(19) United States
(12) Patent Application Publication
(10) Pub. No.: US 2020/0323157 A1
(43) Pub. Date: Oct. 15, 2020

(54) AEROPONIC PLANT GROWING SYSTEM AND ASSOCIATED METHODS

(71) Applicant: Robert F. English, Lakeland, FL (US)

(72) Inventor: Robert F. English, Lakeland, FL (US)

(21) Appl. No.: 16/379,918

(22) Filed: Apr. 10, 2019

(51) Int. Cl. A01G 31/02; A01G 7/00

(52) U.S. Cl. CPC A01G 31/02; A01G 9/047; A01G 7/00

(57) ABSTRACT

An aeroponics plant growing system includes a base housing, a feeding tank within the base housing, a mixing tank within the base housing and in fluid communication with the feeding tank, and a drain tank within the base housing and in fluid communication with the mixing tank. The system also includes a cabinet having a plurality of growing cells with each growing cell separated from an adjacent growing cell and with the cabinet positioned above and supported by the base housing. In addition, the system includes a controller having a memory coupled to a processor and configured to separately control a respective growing environment of each of the growing cells.

### FIELD OF THE INVENTION

The present invention relates to plant growing systems, and more particularly, to an aeroponics growing system and associated methods.

### BACKGROUND OF THE INVENTION

Hydroponic systems have been used for many years to grow plants. Aeroponics is a type of hydroponics which involves growing plants in an air or mist environment without the use of soil. Aeroponics is different from conventional hydroponics. Unlike more conventional hydroponics, which uses water as a growing medium, aeroponics does not make use of water as a growing medium. The combination of root exposure to air along with water mist supplied by the system are used for the plant growth. Advantageously, plants growing in an aeroponics system are exposed to all the ambient carbon dioxide for photosynthesis. Plant pests and diseases are also reduced when using an aeroponics system and typically the aeroponics system may use much less water than conventional hydroponics.

Conventional aeroponics systems differ in the plant support geometry and method of delivery of water nutrient solution. One type of aeroponics system uses a nutrient film technique in which a thin film of nutrient solution is caused to flow by net pots in a gutter type support geometry. Deep flow systems use misters to oxygenate and distribute the nutrients and are termed deep flow because they incorporate a riser into the grow chamber to prevent all the nutrients from draining out. Bubbler aeroponics systems are similar to bucket deep flow aeroponics system in that the roots hang into the nutrient solution in the bottom while being sprayed by misters above and exposed to bubbles from air stones below. Vertical flow systems use a misting or drip distribution of nutrients by gravity feed.

One of the shortcomings of the existing aeroponics systems is the inability to readily size a system to make it efficient for the particular application. Accordingly, what is needed in the art is an aeroponics system that is modular and can be scaled and adapted to particular environments and also a system that is energy, water, and nutrient efficient.

### SUMMARY OF THE INVENTION

It is an object of the invention to provide an aeroponics growing system that provides high yield plant growth through the use of sensors to regulate and automatically control the atmosphere to produce superior plant growth and quality in a shorter period of time than has been previously achieved. As such, the systems and methods set forth herein advantageously provide improved plant growth and efficiency.

An aeroponics plant growing system is disclosed. The system includes a base housing, a feeding tank within the base housing, a mixing tank within the base housing and in fluid communication with the feeding tank, and a drain tank within the base housing and in fluid communication with the mixing tank. The system also includes a cabinet having a plurality of growing cells with each growing cell separated from an adjacent growing cell and with the cabinet positioned above and supported by the base housing. In addition, the system includes a controller having a memory coupled to a processor and configured to separately control a respective growing environment of each of the growing cells.

In a particular aspect, each growing cell of the plurality of growing cells may include a growing platform configured to rotate in place, a motor coupled to the growing platform and configured to rotate the growing platform, and a root box directly underneath the rotational platform and the root box being in fluid communication with the feeding tank. In addition, each growing cell of the plurality of growing cells may also include grow lighting coupled to the controller and configured to bath plants within the respective growing cell with light, a camera coupled to the controller and configured to transmit images of the respective growing cell, a fan coupled to the controller and configured to circulate air within the respective growing cell, and a temperature sensor coupled to the controller and configured to measure a leaf temperature of a plant growing in a respective growing cell. A root box manifold may be in fluid communication with the root box of each growing cell and the feeding tank.

The system may also include a chiller coupled to the controller and in fluid communication with the feeding tank and configured to lower a temperature of a nutrient liquid stored in the feeding tank, and a plurality of nutrient pumps may be coupled to the controller and in fluid communication with the mixing tank and configured to add nutrients to a nutrient liquid stored in the mixing tank.

In addition, the system may include a plurality of spray valves configured to control an amount of nutrient liquid sprayed within a root box of a respective growing cell, where each spray valve is coupled to the controller and configured to be separately operated via the controller, and each root box of the plurality of root boxes comprises a respective drain in fluid communication with the drain tank. The controller may be programmed to detect when a particular growing cell has a plant with a growing deficiency and to adjust at least one of the grow lighting, and a rotational speed of the platform of that particular growing cell. The base housing may include a pair of fork lift pockets that are configured to receive forks of a forklift in order to pick up the system.

The system may include a humidity sensor coupled to the controller and configured to detect a humidity level within the plurality of growing cells, a carbon dioxide monitor coupled to the controller and configured to determine carbon dioxide levels in each of the growing cells, and a heat pump coupled to the controller and in communication with each growing cell to adjust a temperature within a respective growing cell. In addition, a dehumidifier may be coupled to the controller and in fluid communication with each growing cell to adjust a humidity level therein.

The system may include a carbon dioxide supply coupled to the controller and be in fluid communication with each of the growing cells and be configured to deliver carbon dioxide to a respective growing cell in response to the carbon dioxide monitor that is monitoring each of the growing cells. A sensor may be coupled to the controller and configured to monitor at least one of a temperature, pH, and electrical conductivity of a nutrient liquid stored in the feeding tank.

In another particular aspect, a method of aeroponically growing plants within a cabinet having a plurality of growing cells is disclosed. The method includes spraying plants in each grow cell with a nutrient liquid, bathing plants in each grow cell with grow lighting, rotating plants in each grow cell on a platform, and controlling a respective growing environment of each of the growing cells with a controller. The controller is programmed to detect when a particular growing cell has a plant with a growing deficiency and to adjust at least one of the grow lighting, and a rotational speed of the platform of that particular growing cell. The method may also include measuring a leaf temperature of a plant growing in a respective growing cell, adjusting an air temperature of the respective growing cell to meet a programmed leaf temperature growing parameter stored in the controller, and lowering or raising a temperature of the nutrient liquid to meet a programmed nutrient liquid growing parameter stored in the controller.

### BRIEF DESCRIPTION OF THE DRAWINGS

FIG. 1 is a perspective view of an aeroponics plant growing system in which various aspects of the disclosure may be implemented.

FIG. 2 is another perspective view of the aeroponics plant growing system with various components removed for clarity.

FIG. 3 is yet another perspective view of the aeroponics plant growing system with more components removed for clarity.

FIG. 4 is a schematic diagram illustrating how a cabinet of the aeroponics plant growing system is divided.

FIG. 5 is a schematic process diagram of the aeroponics plant growing system illustrated in FIG. 1.

FIG. 6 is a flowchart illustrating a method for operating the aeroponics plant growing system illustrated in FIG. 1.

### DETAILED DESCRIPTION OF PREFERRED EMBODIMENTS

In the summary of the invention, provided above, and in the descriptions of certain preferred embodiments of the invention, reference is made to particular features of the invention, for example, method steps. It is to be understood that the disclosure of the invention in this specification includes all possible combinations of such particular features, regardless of whether a combination is explicitly described. For instance, where a particular feature is disclosed in the context of a particular aspect or embodiment of the invention, that feature can also be used, to the extent possible, in combination with and/or in the context of other particular aspects and embodiments of the invention, and in the invention generally.

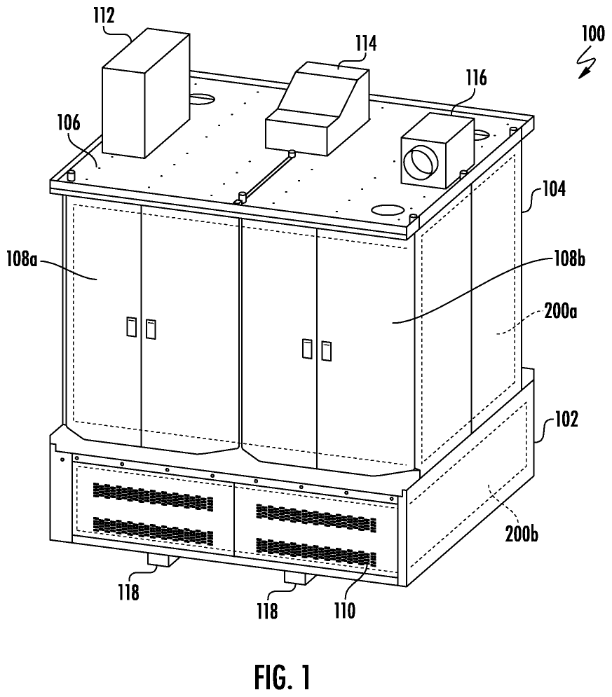

As explained above, there is a need for an aeroponics system that is modular and can be scaled and adapted to particular environments and also a system that is energy, water, and nutrient efficient. Referring now to FIG. 1, an aeroponics plant growing system (the “system”) is generally designated 100. The system includes a base housing 102 that is used to support a cabinet 104. The base housing 102 is generally a rectangular box shape having an interior space for various components of the system 100 that are described in more detail below. The cabinet 104 includes a roof 106 on top, and on the front of the cabinet there is a left side set of doors 108a and a right side set of doors 108b.

A front cover 110 is removably secured over a front of the base housing 102. The front cover 110 can be removed to access the various components that are used in a growing process of the system 100 for maintenance or replacement.

On the roof 106 of the cabinet 104 there is a heat pump 112 that is to control the temperature inside the cabinet 104. In addition, an air cleaner 114 and a de-humidifier 116 may also be positioned on the roof 106 of the cabinet 104 and provide air quality control inside the cabinet 104 in order to maximize plant growth.

The system 100 may be picked up and moved with the assistance of fork lift pockets 118 mounted to the base housing. Accordingly, a fork lift can approach the system 100 from the front and slide its forks into the fork lift pockets 118 and raise the system 100 and move to a new location.

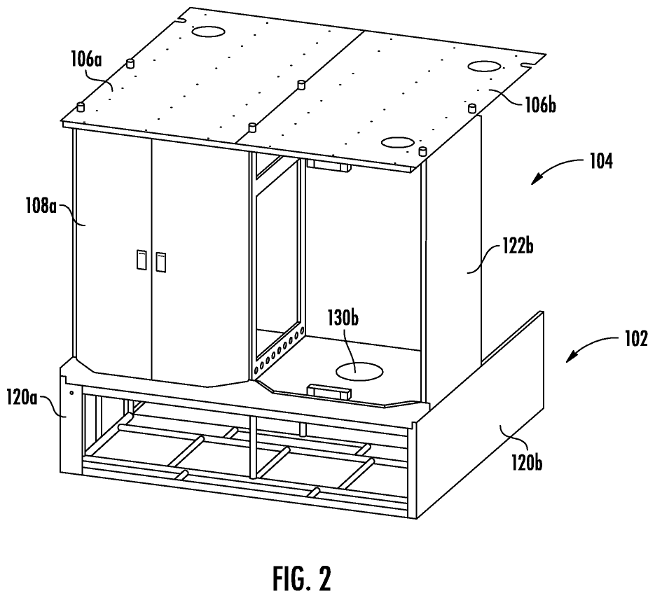

Referring now to FIG. 2, the system 100 is shown with various elements removed for clarity. For example, the front cover 110 has been removed in order to view the interior space of the base housing 102. Also, the right side set of doors 108b of the cabinet 104 have been removed in order to view inside the cabinet 104. Inside the cabinet 104 there is open space in order to place grow cells inside the cabinet 104. The cabinet 104 includes a left side panel 122a and a right side panel 122b. The cabinet includes an aperture for each grow cell. For example, as shown in FIG. 2, there is an aperture 130 in a floor of the cabinet 104 that connects the cabinet 104 to the base housing 102 where various components of the system 100 are housed.

The base housing 102 includes a left side panel 120a and a right side panel 120b on an opposing side of the base housing 102. The left and right side panels 120a, 120b cover the structural framework of the base housing 102 and also provide additional rigidity. The roof 106 includes a left roof panel 106a and a right side roof panel 106b.

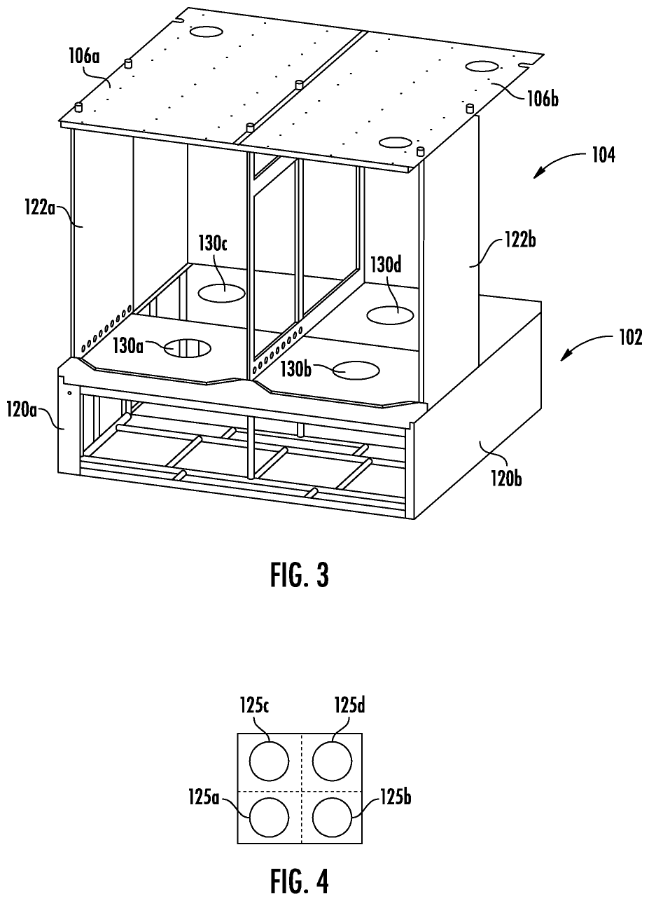

The left side set of doors 108a have been removed in FIG. 3 for clarity. The apertures 130a, 130b, 130c, 130d between the cabinet 104 and base housing 102 are visible. A structural framework of the cabinet 104 is also visible. The apertures 130a, 130b, 130c, 130d, are equidistantly spaced from each other within the cabinet 104. As described in more detail below, the cabinet 104 includes a plurality of growing cells with each growing cell separated from an adjacent growing cell, and the cabinet 104 positioned above and supported by the base housing 102.

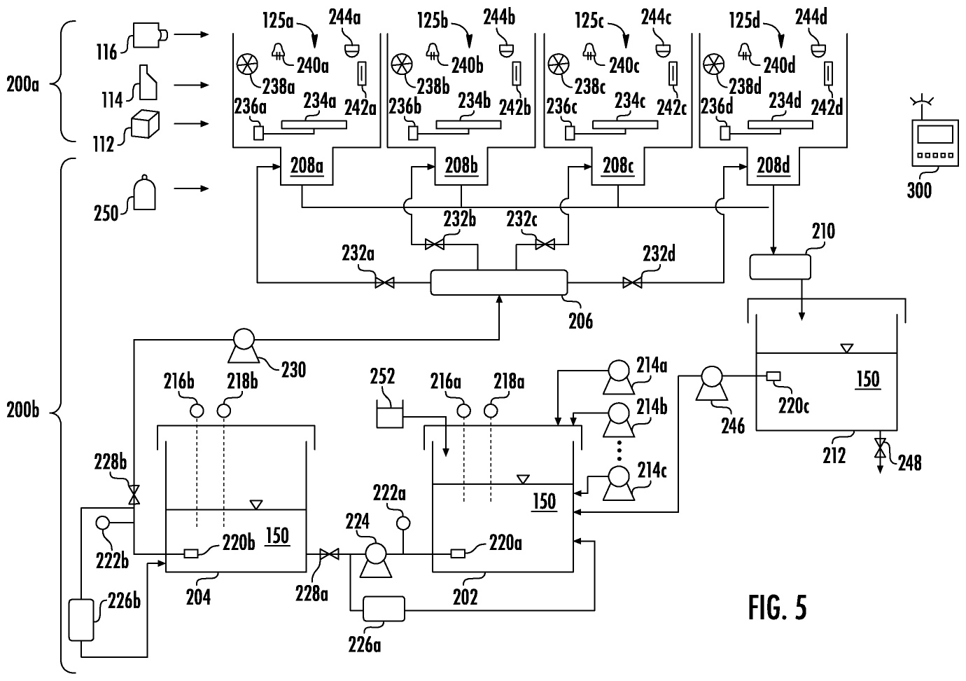

Referring now to FIG. 4, a schematic diagram of how the cabinet 104 is divided is illustrated. In a particular aspect of a top view of the system 100, the cabinet 104 is divided into four equal and identical quadrants for grow cells 125a, 125b, 125c, 125d.

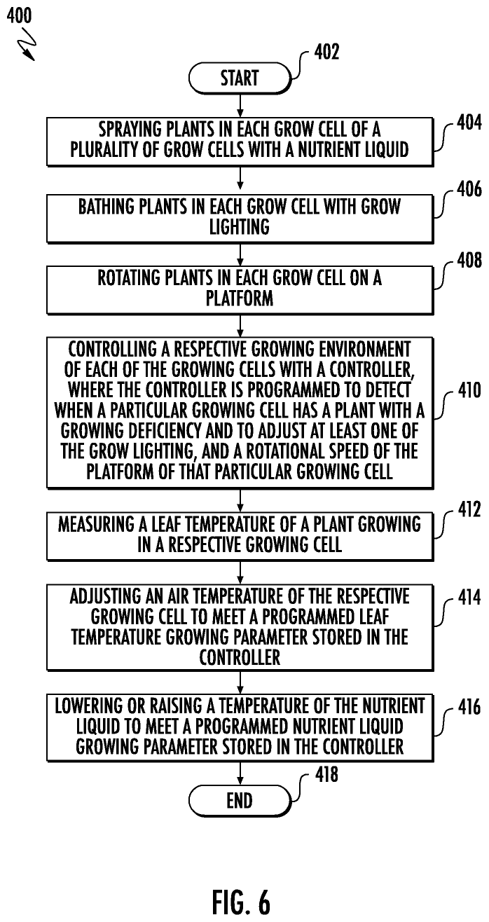

As schematic process diagram of FIG. 5 includes cabinet processes 200a and base housing processes 200b. The cabinet processes 200a are directed to the components located in the cabinet 104 of the system 100 and the base housing processes 200b are directed to the components located in the base housing 102.

A general flow path through the system 100 includes a mixing tank 202 that holds a nutrient liquid 150. Various nutrients are added while the nutrient liquid 150 is in the mixing tank 202. The mixing tank 202 is in fluid communication with a feeding tank 204. The feeding tank 204, in turn, is in fluid communication with a root box spray manifold 206. The root box spray manifold 206 is in fluid communication with each of the root boxes 208a, 208b, 208c, 208d for the respective grow cells 125a, 125b, 125c, 125d. The nutrient liquid 150 is drained from each of the grow cells 125a, 125b, 125c, 125d to a drain manifold 210 that collects the nutrient liquid 150 and directs the nutrient liquid 150 to a drain tank 212. The drain tank 212 is in fluid communication with the mixing tank 202 via a drain transfer pump 246 to complete the recirculation flow path through the system 100. In addition, drain tank 212 includes a drain valve 248 in order to remove excess liquid and other contaminates from the nutrient liquid 150. A water supply 252 is also in fluid communication with the mixing tank 202 in order to replenish the raw water to the nutrient liquid 250 that was removed or absorbed by the growing plants.

A plurality of nutrient pumps 214a-214i are in fluid communication with the mixing tank 202 and each are configured to provide a dosage of a respective nutrient to the nutrient liquid 150 in the mixing tank 202. In addition, a pH meter 216a and electrical conductivity and temperature (EC&T) sensor 218a may be coupled to the controller 300 and be in communication with the nutrient liquid 150 in the mixing tank 202 to analyze the nutrient liquid 150 in the mixing tank 202 to determine any adjustments that may be necessary to the nutrient liquid 150 (e.g., what nutrients to add and how much). A suction strainer 220a is positioned proximate a bottom of the mixing tank 202 and is used to draw the nutrient liquid 150 from the mixing tank 202 to the feeding tank 204.

A transfer pump 224 is used to pump the nutrient liquid 150 from the mixing tank 202 to the feeding tank 204. In addition, a temperature sensor 222a is coupled between the mixing tank 202 and the feeding tank 204 to detect when the temperature of the nutrient liquid 150 is not in compliance with the growing parameters. The growing parameters include temperature and the nutrient composition of the nutrient liquid 150 among other things. The growing parameters are programmed into a controller 300 that is coupled to the various components of the system 100 and is configured to operate the various components (transfer pumps, valves, etc.) as needed in response to feedback from the sensors throughout the system 100.

If the temperature of the nutrient liquid 150 being pumped from the mixing tank 202 is not in compliance with the growing parameters (e.g., too hot), then valve 228a is closed via a command from the controller 300 and the nutrient liquid 150 is directed through a chiller 226a to reduce the temperature of the nutrient liquid 150 and recirculated back through the mixing tank 202 until the temperature is in compliance with the growing parameter before it is allowed to flow to the feeding tank 204. Once the temperature of the nutrient liquid 150 is determined to be in compliance with the growing parameters, valve 228a opens and the nutrient liquid 150 enters the feeding tank 204.

Once the nutrient liquid 150 is in the feeding tank 204, the nutrient liquid 150 is again analyzed using a pH meter 216b and an EC&T sensor 218b. Similar to the process in the mixing tank 202, if the nutrient liquid 150 is not in compliance with the growing parameters then adjustments are made. A root box pump 230 is configured to pump the nutrient liquid 150 from the feeding tank 204 to the root box manifold 206. A temperature sensor 222b is configured to test the temperature of the nutrient liquid 150 being pumped to the root box manifold 206. When the temperature of the nutrient liquid 150 is not in compliance with the growing parameters, valve 222b is closed via controller 300 and the nutrient liquid 150 is directed to chiller 226b to reduce the temperature of the nutrient liquid 150. The nutrient liquid 150 is recirculated through the feeding tank 204 and back through the chiller 226b until the temperature of the nutrient liquid 150 is in compliance with the growing parameters.

Once the nutrient liquid 150 is in compliance with the growing parameters, then valve 228b is opened via controller 300 and the nutrient liquid 150 is pumped to the root box manifold 206 where it is distributed to the respective root boxes 208a, 208b, 208c, 208d. A respective spray valve 232a, 232b, 232c, 232d is coupled between the root boxes and the root box manifold 206 and each can be closed or opened by the controller 300 in order to deliver more or less nutrient liquid 150 to the respective root box 208a, 208b, 208c, 208d. Each spray valve 232a, 232b, 232c, 232d is configured to be separately operated via the controller 300.

As described above, the cabinet 104 houses four grow cells 125a, 125b, 125c, 125d within a respective quadrant (see FIG. 4). Each of the grow cells 125a, 125b, 125c, 125d, includes a rotatable growing platform 234a, 234b, 234c, 234d coupled to a respective motor 236a, 236b, 236c, 236d that is configured to rotate the respective growing platform 234a, 234b, 234c, 234d for a duration and speed according to the growing parameters. A fan 238a, 238b, 238c, 238d is positioned within each respective grow cell 125a, 125b, 125c, 125d in order to provide the desired ventilation and air circulation to maximize growth of the plants. Grow lighting 240a, 240b, 240c, 240d is mounted within the respective grow cells 125a, 125b, 125c, 125d and is programmed to be operated by the controller 300 to turn on and off in accordance with the growing parameters.

In addition, a combined temperature sensor and carbon dioxide monitor 242a, 242b, 242c, 242d is within each respective grow cell 125a, 125b, 125c, 125d and is used to detect the temperature and to turn on the heat pump 112 via the controller 300 when the temperature is not in compliance with the growing parameters. The temperature sensor 242a-d is configured to measure a leaf temperature of a plant growing in a respective growing cell. The controller 300, in response to the combined temperature sensor and carbon dioxide monitor 242a, 242b, 242c, 242d, is configured to cause a rise in temperature (via heat pump 112, for example) within a respective growing cell 125a, 125b, 125c, 125d in response to any growing deficiencies that are detected or when the temperature is not in compliance with the growing parameters for a particular growing cell.

A camera 244a, 244b, 244c, 244d may also be positioned within each growing cell 125a, 125b, 125c, 125d in order to view inside a respective growing cell without opening the cabinet 104 and adversely affecting the growing environment therein. The camera 244a, 244b, 244c, 244d is configured to transmit images of the respective growing cell to the controller 300.

As described above, the system includes a heat pump 112 in communication with the growing cells 125a, 125b, 125c, 125d to adjust a temperature within a respective growing cell. In addition, a dehumidifier 116 may be coupled to the controller and be in fluid communication with each growing cell 125a, 125b, 125c, 125d to adjust a humidity level therein. The air cleaner 114 provides air quality control inside the cabinet 104 in order to maximize plant growth.

The system 100 may include a carbon dioxide supply 250 coupled to the controller 300 and be in fluid communication with each of the growing cells 125a, 125b, 125c, 125d and be configured to deliver carbon dioxide to a respective growing cell in response to the carbon dioxide monitor 242a, 242b, 242c, 242d that is monitoring each of the growing cells. The carbon dioxide monitor may also include a humidity sensor coupled to the controller 300 and configured to detect a humidity level within the plurality of growing cells.

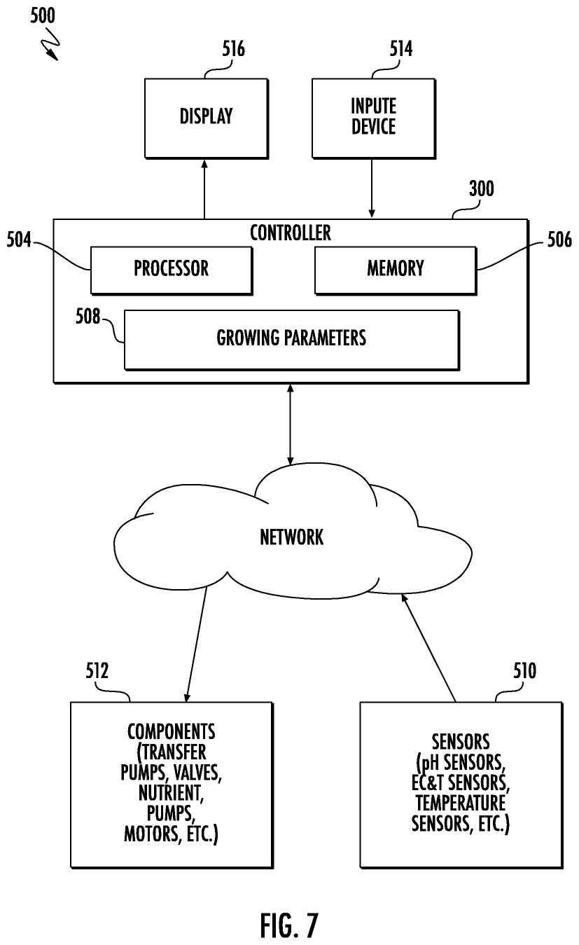

Referring now to the flowchart 400 in FIG. 6, and generally speaking, a method of operating the system 100 illustrated in FIGS. 1-5 will be discussed. From the start, at 402, the method of aeroponically growing plants within a cabinet having a plurality of growing cells includes spraying plants in each grow cell with a nutrient liquid, at 404, and bathing plants in each grow cell with grow lighting.

Moving to 408, the method includes rotating plants in each grow cell on a platform and, at 410, controlling a respective growing environment of each of the growing cells with a controller. The controller is programmed to detect when a particular growing cell has a plant with a growing deficiency and to adjust at least one of the grow lighting, and a rotational speed of the platform of that particular growing cell. In addition, the method may also include, at 412, measuring a leaf temperature of a plant growing in a respective growing cell, and adjusting, at 414, an air temperature of the respective growing cell to meet a programmed leaf temperature growing parameter stored in the controller. The method also includes, at 416, lowering or raising a temperature of the nutrient liquid to meet a programmed nutrient liquid growing parameter stored in the controller.

FIG. 7 depicts a block diagram of a computing system 500 illustrating a suitable computing operating environment in which various aspects of the disclosure may be implemented. The computing system 500 includes a controller 300 having at least one processor 504, and a memory 506 communicatively coupled to the at least one processor 504. The controller 300 is configured to separately control a respective growing environment of each of the growing cells 125a, 125b, 125c, 125d. The controller 300 is programmed to detect when a particular growing cell has a plant with a growing deficiency and to adjust at least one of the grow lighting, and a rotational speed of the platform of that particular growing cell.

The processor 504 is configured to receive data from sensors (e.g. pH sensor 216, EC&T sensor 218, temperature sensor 222, etc., collectively 510) and compare to the growing parameters 508 of the system 100. The processor 504 is also configured to control and adjust the components (transfer pump 224, valve 228, nutrient pump 214, etc., collectively 512) of the system 100 so that the growing cells are operating in compliance with the growing parameters 508 to maximize plant growth in each growing cell. The growing parameters 508 can be entered using an input device 514 coupled to the controller 300. In addition, the feedback and data from the sensors 510 and components 512 can be monitored on a display 516.

The illustrated computing system 500 is shown merely as having an example controller, and may be implemented by any computing or processing environment with any type of machine or set of machines that may have suitable hardware and/or software capable of operating as described herein.

The processor(s) 504 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. In some embodiments, the processor 504 may be one or more physical processors, or one or more virtual (e.g., remotely located or cloud) processors. A processor 504 including multiple processor cores and/or multiple processors may provide functionality for parallel, simultaneous execution of instructions or for parallel, simultaneous execution of one instruction on more than one piece of data.

In general, the foregoing description is provided for exemplary and illustrative purposes; the present invention is not necessarily limited thereto. Rather, those skilled in the art will appreciate that additional modifications, as well as adaptations for particular circumstances, will fall within the scope of the invention as herein shown and described and of the claims appended hereto.

What is claimed is:

1. An aeroponics plant growing system comprising:
a base housing;
a feeding tank within the base housing;
a mixing tank within the base housing and in fluid communication with the feeding tank;
a drain tank within the base housing and in fluid communication with the mixing tank;
a cabinet having a plurality of growing cells with each growing cell separated from an adjacent growing cell, the cabinet positioned above and supported by the base housing; and
a controller having a memory coupled to a processor and configured to separately control a respective growing environment of each of the growing cells.

2. The system of claim 1, wherein each growing cell of the plurality of growing cells comprises:
a growing platform configured to rotate in place;
a motor coupled to the growing platform and configured to rotate the growing platform; and
a root box directly underneath the rotational platform and the root box being in fluid communication with the feeding tank.

3. The system of claim 2, wherein each growing cell of the plurality of growing cells comprises:
grow lighting coupled to the controller and configured to bath plants within the respective growing cell with light;
a camera coupled to the controller and configured to transmit images of the respective growing cell;
a fan coupled to the controller and configured to circulate air within the respective growing cell; and
a temperature sensor coupled to the controller and configured to measure a leaf temperature of a plant growing in a respective growing cell.

4. The system of claim 1, further comprising a root box manifold in fluid communication with the root box of each growing cell and the feeding tank.

5. The system of claim 1, further comprising a chiller coupled to the controller and in fluid communication with the feeding tank and configured to lower a temperature of a nutrient liquid stored in the feeding tank.

6. The system of claim 1, further comprising a plurality of nutrient pumps coupled to the controller and in fluid communication with the mixing tank and configured to add nutrients to a nutrient liquid stored in the mixing tank.

7. The system of claim 1, further comprising a plurality of spray valves configured to control an amount of nutrient liquid sprayed within a root box of a respective growing cell, each spray valve coupled to the controller and configured to be separately operated via the controller.

8. The system of claim 2, wherein each root box of the plurality of root boxes comprises a respective drain in fluid communication with the drain tank.

9. The system of claim 3, wherein the controller is programmed to detect when a particular growing cell has a plant with a growing deficiency and to adjust at least one of the grow lighting, and a rotational speed of the platform of that particular growing cell.

10. The system of claim 1, the base further comprising a pair of fork lift pockets configured to receive forks of a forklift in order to pick up the system.

11. The system of claim 1, further comprising a humidity sensor coupled to the controller and configured to detect a humidity level within the plurality of growing cells.

12. The system of claim 1, further comprising a carbon dioxide monitor coupled to the controller and configured to determine carbon dioxide levels in each of the growing cells.

13. The system of claim 1, further comprising a heat pump coupled to the controller and in communication with each growing cell to adjust a temperature within a respective growing cell.

14. The system of claim 1, further comprising a dehumidifier coupled to the controller and in fluid communication with each growing cell to adjust a humidity level therein.

15. The system of claim 12, further comprising a carbon dioxide supply coupled to the controller and in fluid communication with each of the growing cells and configured to deliver carbon dioxide to a respective growing cell in response to the carbon dioxide monitor that is monitoring each of the growing cells.

16. The system of claim of 1, further comprising at a sensor coupled to the controller and configured to monitor at least one of a temperature, pH, and electrical conductivity of a nutrient liquid stored in the feeding tank.

17. An aeroponics plant growing system comprising:
a base housing;
a feeding tank within the base housing;
a mixing tank within the base housing and in fluid communication with the feeding tank;
a drain tank within the base housing and in fluid communication with the mixing tank;
a cabinet having a plurality of growing cells with each growing cell separated from an adjacent growing cell, the cabinet positioned above and supported by the base housing;
grow lighting coupled to the controller and configured to bath plants within the respective growing cell with light;
a growing platform configured to rotate in place;
a motor coupled to the growing platform and configured to rotate the growing platform; and
a controller having a memory coupled to a processor and configured to separately control a respective growing environment of each of the growing cells, wherein the controller is programmed to detect when a particular growing cell has a plant with a growing deficiency and to adjust at least one of the grow lighting, and a rotational speed of the platform of that particular growing cell.

18. The system of claim 17, wherein each growing cell of the plurality of growing cells comprises a root box directly underneath the rotational platform and the root box being in fluid communication with the feeding tank.

19. A method of aeroponically growing plants within a cabinet having a plurality of growing cells, the method comprising:
spraying plants in each grow cell with a nutrient liquid;
bathing plants in each grow cell with grow lighting;
rotating plants in each grow cell on a platform;
controlling a respective growing environment of each of the growing cells with a controller, wherein the controller is programmed to detect when a particular growing cell has a plant with a growing deficiency and to adjust at least one of the grow lighting, and a rotational speed of the platform of that particular growing cell.

20. The method of claim 19, further comprising:
measuring a leaf temperature of a plant growing in a respective growing cell;
adjusting an air temperature of the respective growing cell to meet a programmed leaf temperature growing parameter stored in the controller;
lowering or raising a temperature of the nutrient liquid to meet a programmed nutrient liquid growing parameter stored in the controller.
